(19) United States
(12) Patent Application Publication
(10) Pub. No.: US 2025/0229919 A1
(43) Pub. Date: Jul. 17, 2025

(54) SPEED CONTROL METHOD, DEVICE, MULTI-ROTOR UNMANNED AERIAL VEHICLE AND STORAGE MEDIUM

(71) Applicant: AUTEL ROBOTICS CO., LTD., Shenzhen (CN)

(72) Inventor: Baoxu JIA, Shenzhen (CN)

(21) Appl. No.: 19/004,275

(22) Filed: Dec. 28, 2024

(30) Foreign Application Priority Data
Dec. 28, 2023 (CN) 202311842650.6

(51) Int. Cl. B64U 50/18; G05D 1/65; G05D 109/25

(52) U.S. Cl. CPC B64U 50/18; G05D 1/65; G05D 2109/254

(57) ABSTRACT

Embodiments of the present application relate to the technical field of unmanned aerial vehicles, and particularly relate to a speed control method, device, multi-rotor unmanned aerial vehicles and a storage medium. The speed control method is applied to a multi-rotor unmanned aerial vehicle, the method including: acquiring a speed adjustment command and obtaining an acceleration adjustment command according to the speed adjustment command; obtaining a specific force acceleration adjustment command according to the acceleration adjustment command; and adjusting a current thrust of the multi-rotor unmanned aerial vehicle to a target thrust according to the specific force acceleration adjustment command, so as to realize the adjustment of a flight speed of the multi-rotor unmanned aerial vehicle. The above-mentioned method can ensure the speed control over multi-rotor unmanned aerial vehicle at any attitude such as continuous rolling and has a wider application range.

### BACKGROUND

This application claims the benefit of and priority to Chinese Application No. 2023118426506, filed 28 Dec. 2023, the entirety of which is hereby incorporated herein by reference.

### TECHNICAL FIELD

Embodiments of the present application relate to the technical field of unmanned aerial vehicles, and particularly relate to a speed control method, device, multi-rotor unmanned aerial vehicles and a storage medium.

### RELATED ART

With the continuous development of unmanned aerial vehicle technology, unmanned aerial vehicle (UAV) has been widely used in many fields. The multi-rotor unmanned aerial vehicle has been playing an important role in many fields by virtue of equipped multiple rotors, such as photography, agriculture, logistics, security and so on, because of its high vertical take-off and hovering capability, high maneuverability, maneuverability and low cost. The multi-rotor unmanned aerial vehicles need to be able to accurately control their own flight speed when performing these related tasks, so the speed control over multi-rotor unmanned aerial vehicles is a very critical capability. A common speed control method of a multi-rotor unmanned aerial vehicle is to change the direction of thrust by controlling the attitude of the multi-rotor unmanned aerial vehicle so as to adjust the speed of the multi-rotor unmanned aerial vehicle, and the attitude of the multi-rotor unmanned aerial vehicle is represented by an Euler angle and is controlled by an angular speed, that is to say, the attitude of the multi-rotor unmanned aerial vehicle needs to be changed by changing the angular speed of the Euler angle of the multi-rotor unmanned aerial vehicle, and the direction of thrust is controlled by controlling the attitude so as to change the flight speed of the unmanned aerial vehicle.

However, this method uses the Euler angle to represent the attitude of the multi-rotor unmanned aerial vehicle. When the multi-rotor unmanned aerial vehicle rotates in the space, the angular speed of the Euler angle is non-continuous, so it will produce non-continuous angular speed command, which brings great difficulties to the speed control over the multi-rotor unmanned aerial vehicle, especially it is difficult for the multi-rotor unmanned aerial vehicle to achieve speed control over continuous rolling.

### SUMMARY

An object of the embodiments of the present application is to provide a speed control method, device, multi-rotor unmanned aerial vehicle and a storage medium, so as to solve the technical problem that the prior art realizing the speed control over an unmanned aerial vehicle by adjusting the angular speed of a Euler angle results in a poor speed control effect of the multi-rotor unmanned aerial vehicle in an application scenario such as continuous rolling.

In a first aspect, a speed control method applied to a multi-rotor unmanned aerial vehicle is provided, the method comprising: acquiring a speed adjustment command and obtaining an acceleration adjustment command according to the speed adjustment command; obtaining a specific force acceleration adjustment command according to the acceleration adjustment command; and adjusting a current thrust of the multi-rotor unmanned aerial vehicle to a target thrust according to the specific force acceleration adjustment command, so as to realize the adjustment of a flight speed of the multi-rotor unmanned aerial vehicle.

In combination with the first aspect, as a possible embodiment, the acquiring a speed adjustment command and obtaining an acceleration adjustment command according to the speed adjustment command includes: acquiring a target speed in the speed adjustment command when the speed adjustment command is received; calculating a target acceleration from the target speed and the current speed of the multi-rotor unmanned aerial vehicle from a proportion controller; and forming an acceleration adjustment command according to the target acceleration.

In combination with the first aspect, as a possible embodiment, wherein the obtaining the specific force acceleration adjustment command for the multi-rotor unmanned aerial vehicle according to the acceleration adjustment command includes: obtaining a target angular acceleration adjustment command according to a target acceleration in the acceleration adjustment command, wherein the target angular acceleration adjustment command is used for achieving control over a thrust direction; obtaining a target specific force acceleration magnitude adjustment command according to a target acceleration in the acceleration adjustment command; and forming the specific force acceleration adjustment command of the multi-rotor unmanned aerial vehicle according to the target angular acceleration adjustment command and the target specific force acceleration magnitude adjustment command.

In conjunction with the first aspect, as one possible embodiment, the obtaining the target angular acceleration adjustment command according to the target acceleration in the acceleration adjustment command includes: calculating a direction of the target specific force acceleration from the target acceleration in the acceleration adjustment command; taking a unit vector perpendicular to the direction of the target specific force acceleration and the direction of the current specific force acceleration of the multi-rotor unmanned aerial vehicle as an axis vector; calculating an included angle value from the direction of the target specific force acceleration and the direction of the current specific force acceleration; rotating the current specific force acceleration about the axis vector by the included angle value to obtain a target angular speed; and obtaining the target angular acceleration adjustment command of the multi-rotor unmanned aerial vehicle according to the target angular speed.

In combination with the first aspect, as one possible embodiment, the obtaining the target angular acceleration adjustment command of the multi-rotor unmanned aerial vehicle according to the target angular speed includes: performing control allocation processing on the target angular speed based on an INDI controller, and forming the target angular acceleration adjustment command of the multi-rotor unmanned aerial vehicle according to the processing result.

In conjunction with the first aspect, as one possible embodiment, the obtaining the target specific force acceleration magnitude adjustment command according to the target acceleration in the acceleration adjustment command includes: calculating a magnitude of the target specific force acceleration from the target acceleration in the acceleration adjustment command; calculating a target thrust acceleration magnitude of the multi-rotor unmanned aerial vehicle from the magnitude of the target specific force acceleration and the magnitude of the drag acceleration received by the multi-rotor unmanned aerial vehicle; and forming a target specific force acceleration magnitude adjustment command according to the target thrust acceleration magnitude.

In combination with the first aspect, as one possible embodiment, the forming the specific force acceleration adjustment command of the multi-rotor unmanned aerial vehicle according to the target angular acceleration adjustment command and the target specific force acceleration magnitude adjustment command includes: performing control allocation on the target angular acceleration adjustment command and the target specific force acceleration magnitude adjustment command by using an unmanned aerial vehicle dynamic model, and forming the specific force acceleration adjustment command of the multi-rotor unmanned aerial vehicle according to the allocation result.

In a second aspect, a speed control device applied to a multi-rotor unmanned aerial vehicle is provided, the device including: an acquisition module configured to acquire a speed adjustment command; an obtaining module configured to obtain a specific force acceleration adjustment command according to the acceleration adjustment command; and obtain a specific force acceleration adjustment command according to the acceleration adjustment command; and an adjustment module configured to adjust a current thrust of the multi-rotor unmanned aerial vehicle to a target thrust according to the specific force acceleration adjustment command, so as to realize the adjustment of a flight speed of the multi-rotor unmanned aerial vehicle.

In a third aspect, a multi-rotor unmanned aerial vehicle is provided, which includes a memory and a processor, and a predetermined number of strain gauge pressure sensors respectively arranged in a seat pad, a foot pad and a backrest of a seat, each strain gauge pressure sensor and the memory being connected to the processor, the processor being adapted to execute one or more computer programs stored in the memory, the processor, when executing the one or more computer programs, causing the multi-rotor unmanned aerial vehicle to implement the method according to the first aspect.

In a fourth aspect, a computer readable storage medium is provided, which has stored thereon a computer program comprising program commands which, when executed by a processor, cause the processor to perform the method according to the first aspect.

The embodiments of the present application can achieve the following technical effects: the multi-rotor unmanned aerial vehicle acquires a speed adjustment command and obtains a specific force acceleration adjustment command according to the speed adjustment command; obtains a specific force acceleration adjustment command according to the acceleration adjustment command; and adjusts a current thrust of the multi-rotor unmanned aerial vehicle to a target thrust according to the specific force acceleration adjustment command, so as to realize the adjustment of a flight speed of the multi-rotor unmanned aerial vehicle. The above-mentioned method can directly obtain the acceleration adjustment command from the speed adjustment command, and then obtain the specific force acceleration adjustment command from the acceleration command, and does not generate the attitude command, so it is not limited by the attitude of the multi-rotor unmanned aerial vehicle, and can ensure the speed control over the multi-rotor unmanned aerial vehicle at any attitude such as continuous rolling, and has a wider application range.

### BRIEF DESCRIPTION OF THE DRAWINGS

In order to illustrate the technical solutions of the embodiments of the present application more clearly, the drawings used in the description of the embodiments of the present application will be briefly described, and it is obvious that the drawings in the following description are only some embodiments of the present application, and that other drawings can be obtained according to these drawings without involving any inventive effort for a person skilled in the art.

FIG. 1 is a schematic structural diagram showing a multi-rotor unmanned aerial vehicle according to an embodiment of the present application;

FIG. 2 is a schematic flow diagram showing a speed control method according to an embodiment of the present application;

FIG. 3A is a schematic diagram showing a relationship between a target specific force acceleration and a target acceleration according to an embodiment of the present application;

FIG. 3B is a schematic diagram showing a relationship between a target specific force acceleration and a target thrust acceleration according to an embodiment of the present application;

FIG. 4 is a schematic diagram showing a relationship between a thrust direction and a specific force direction according to an embodiment of the present application;

FIG. 5 is a schematic structural diagram showing a speed control device according to an embodiment of the present application; and

FIG. 6 is a schematic structural diagram showing a multi-rotor unmanned aerial vehicle according to an embodiment of the present application.

### DETAILED DESCRIPTION

For the that the objects, aspects and advantages of the present application may be more clearly understood, a more particular description of the invention, briefly summarized below, may be had by reference to the appended drawings and examples. It should be understood that the particular embodiments described herein are illustrative only and are not restrictive. Based on the embodiments in the present application, all other embodiments obtained by a person skilled in the art without involving any inventive effort are within the scope of protection of the present application.

It should be noted that, if not in conflict, the various features of the embodiments of the present application may be combined with of the present application. In addition, although the division of functional modules is illustrated in a schematic diagram showing an device and a logical order is illustrated in a flowchart, in some cases, the steps illustrated or described may be performed in an order other than the division of the modules the device or in the flowchart. Furthermore, the words “first”, “second”, “third”, etc., as used herein do not limit the data and order of execution, but merely distinguish the same item or similar item having substantially the same function or action.

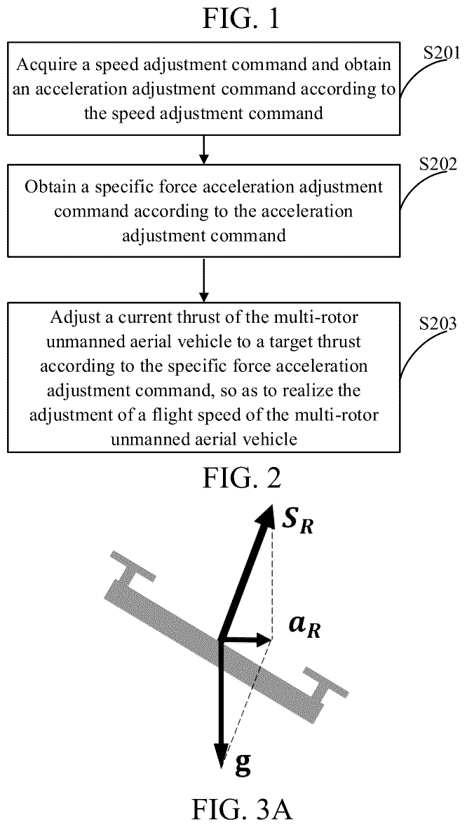

In order to facilitate the understanding of the present application, firstly, the present application relates to a multi-rotor unmanned aerial vehicle. The multi-rotor unmanned aerial vehicle referred to in the present application is an unmanned aerial vehicle. With reference to FIG. 1, a schematic structural diagram showing a multi-rotor unmanned aerial vehicle provided in the embodiment of the present application is shown. The multi-rotor unmanned aerial vehicle shown in FIG. 1 is a four-rotor unmanned aerial vehicle, i.e., having four rotors. It can be seen from FIG. 1 that the four-rotor unmanned aerial vehicle comprises necessary components such as a fuselage, a bracket and a rotor, wherein each rotor can correspond to a motor, and the motor generates a rotational speed so as to control the rotors to generate thrust, thereby controlling the speed change of the multi-rotor unmanned aerial vehicle. In other embodiments, the multi-rotor unmanned aerial vehicle may have other numbers of rotors, such as six rotors, eight rotors, etc., each of which may be independently controlled to enable the multi-rotor unmanned aerial vehicle to perform diverse flight maneuvers.

As a possible embodiment, the speed control method of the multi-rotor unmanned aerial vehicle is to change the direction of thrust by controlling the attitude of the multi-rotor unmanned aerial vehicle so as to provide acceleration in a specified direction, thereby changing the flight speed of the multi-rotor unmanned aerial vehicle. The attitude of the unmanned aerial vehicle is expressed by the Euler angle, which refers to a Roll angle, a Pitch angle and a Yaw angle, etc. and can be controlled by the angular speed. However, when the multi-rotor unmanned aerial vehicle rotates in the space, the angular speed of the Euler angle is non-continuous, so it will produce non-continuous angular speed command, which brings great difficulties to the speed control over the multi-rotor unmanned aerial vehicle, especially it is difficult for the multi-rotor unmanned aerial vehicle to achieve speed control over continuous rolling.

By way of example, the Roll angle, Pitch angle and Yaw angle have angular ranges of [−π,π], (−π/2,π/2] and (−π,π]), respectively, and when the Roll angle, Pitch angle and Yaw angle of the aircraft are [0 deg., 89 deg., and 0 deg.], if a positive pitching moment is applied, the Pitch angle will first increase to 90 deg. and then start to decrease, while at the instant when the Pitch angle reaches 90 deg., the angle of the Yaw angle will change from 0 to 180 deg. (or −180 deg.) and the angle of the Roll angle will also change from 0 to 180 deg. (or −180 deg.). At present, the speed control method of the multi-rotor unmanned aerial vehicle is to convert the speed command into an acceleration command, then convert same into an angular speed command for changing the attitude, and then control the attitude so as to change the flight speed; however, it can be seen from the above-mentioned example that the angles of the three Euler angles are not continuously changed, and such a discontinuity of the Euler angles will generate a discontinuous angular speed command, and the multi-rotor unmanned aerial vehicle cannot perform speed control well, especially when the multi-rotor unmanned aerial vehicle continuously rolls.

In view of this, the present application proposes a speed control method and device, a multi-rotor unmanned aerial vehicle and a storage medium, which can perform speed control without using an Euler angle, thereby improving the scope of application of the speed control. The speed control method according to the present application will first be described.

With reference to FIG. 2, a schematic flow diagram of a speed control method provided in the present application is shown. The speed control method shown in FIG. 2 is applied to a multi-rotor unmanned aerial vehicle, and as an example, the multi-rotor unmanned aerial vehicle may be as shown in FIG. 1. It should be noted that the speed control method shown in the present application is realized by an axis angle method, which refers to realizing the control over acceleration and thus speed by changing the magnitude and direction of the total thrust formed by each rotor of the multi-rotor unmanned aerial vehicle. In particular, the method comprises:

S201 Acquire a speed adjustment command and obtain an acceleration adjustment command according to the speed adjustment command.

It should be noted that the speed adjustment command refers to an command for changing the flight speed of the multi-rotor unmanned aerial vehicle, wherein the command comprises a target speed to which the multi-rotor unmanned aerial vehicle is expected to be adjusted, and it can be understood that the target speed comprises two dimensions of a target speed magnitude and a target speed direction.

As one possible embodiment, the speed adjustment command may be issued by a user via a control terminal communicatively coupled to the multi-rotor unmanned aerial vehicle. For example, when a user wants to adjust the flight speed of the multi-rotor unmanned aerial vehicle, a desired flight speed magnitude and direction may be set on the control terminal, which forms a speed adjustment command according to the user's setting and sends it to the multi-rotor unmanned aerial vehicle.

As another possible embodiment, the speed adjustment command may also be automatically generated by the multi-rotor unmanned aerial vehicle based on the current environment and flight states. For example, if the multi-rotor unmanned aerial vehicle is flying directly in front of the aircraft, where a interferent is present, the multi-rotor unmanned aerial vehicle may generate speed adjustment commands for reducing the flight speed or changing the flight direction. Of course, this is by way of example only, and in other embodiments, the multi-rotor unmanned aerial vehicle may acquire the speed adjustment command in other manners, which is not limited by the present application.

It should also be noted that the target acceleration refers to the flight acceleration of the multi-rotor unmanned aerial vehicle.

In one embodiment, the S201 step includes: a target speed in the speed adjustment command is acquired when the speed adjustment command is received; a target acceleration is calculated from the target speed and the current speed of the multi-rotor unmanned aerial vehicle from a proportion controller; and an acceleration adjustment command is formed according to the target acceleration.

As a possible embodiment, the proportion controller may be a PID controller (Proportion Integration Differentiation). The PID controller consists of a proportional unit P, an integral unit I and a differential unit D. By setting three parameters Kp, Ki and Kd, the PID controller may compare the collected data to one reference value and then use this difference to calculate a new input value for the purpose of allowing the data of the system to reach or remain at the reference value. Unlike other simple control operations, the PID controller can adjust input values based on historical data and the occurrence of differences, which can make the system more accurate and stable.

For example, based on the proportion controller, a target acceleration is calculated from the target speed and the current speed of the multi-rotor unmanned aerial vehicle, and the following formula can be satisfied:

$${a}_{R} = - {K}_{P} * ( {V}_{R} - V ) + {\dot{V}}_{R}$$

where a_{R} represents a target acceleration, Kₚ represents a proportion control gain (the proportion control gain can be a reference range calculated empirically by an engineer, and the multi-rotor unmanned aerial vehicle can adjust in real time within the reference range according to needs), V_{R} represents the target speed, V represents the current speed of the multi-rotor unmanned aerial vehicle, and V_{R} represents a derivative of the target speed.

S202 Obtain a specific force acceleration adjustment command according to the acceleration adjustment command.

It should be noted that the specific force refers to the combined external force of the unmanned aerial vehicle in addition to its own gravity, and for the multi-rotor unmanned aerial vehicle, the specific force is also the sum of the total thrust and resistance of each rotor of the multi-rotor unmanned aerial vehicle. The specific force acceleration is a value obtained by dividing the target specific force by the mass of the multi-rotor unmanned aerial vehicle.

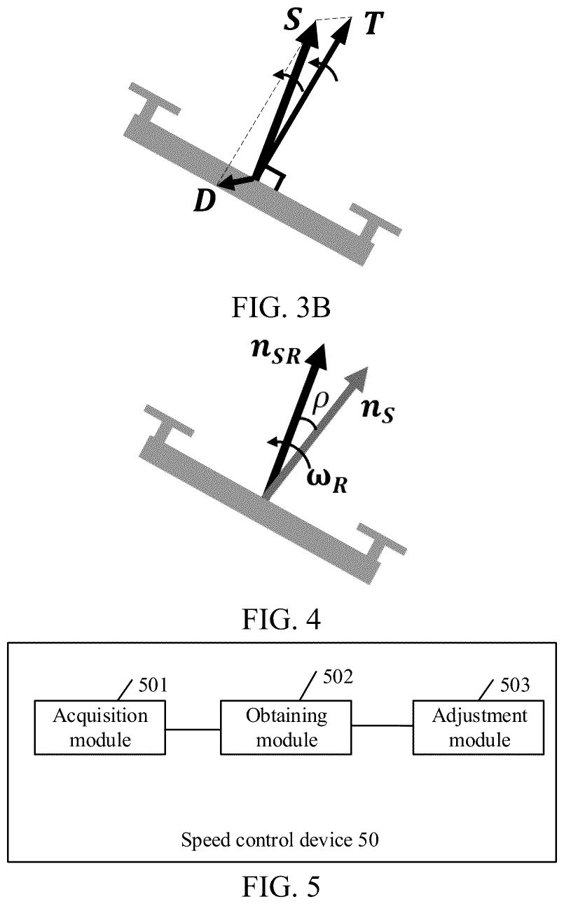

For example, referring to FIG. 3A, in FIG. 3A, S_{R} represents the target specific force acceleration, a_{R} represents the target acceleration, and g represents the gravitational acceleration, and the three values satisfy the following equations:

S_{R}=a_{R}−g

According to the above formula, the target specific force acceleration can be solved from the target acceleration. Furthermore, since the specific force acceleration is also the sum of the total thrust acceleration and the drag acceleration of each rotor of the multi-rotor unmanned aerial vehicle, the direction of the total thrust of the multi-rotor unmanned aerial vehicle is always connected with the fuselage, and the value of the drag acceleration is unchanged compared with the thrust acceleration. Therefore, in practical control, the multi-rotor unmanned aerial vehicle can adjust the magnitude and direction of the specific force acceleration by adjusting the magnitude and direction of the thrust acceleration of the multi-rotor unmanned aerial vehicle, and in order to facilitate the unmanned aerial vehicle to execute a control command, the specific force acceleration adjustment command shown in the present application is actually used for adjusting the thrust of the multi-rotor unmanned aerial vehicle.

For example, referring to FIG. 3B, T_{R} represents the target thrust acceleration of each rotor of the multi-rotor unmanned aerial vehicle, D represents the drag acceleration experienced by the multi-rotor unmanned aerial vehicle, and T_{R}, D, and S_{R} satisfy the following equations:

T_{R}=S_{R}−D

As one possible embodiment, the specific force acceleration adjustment command may include the magnitude and direction of the target thrust acceleration to which the multi-rotor unmanned aerial vehicle is expected to adjust.

In one embodiment, the step S202 comprises:

S2021 Obtain a target angular acceleration adjustment command according to the target acceleration in the acceleration adjustment command.

The target angular acceleration adjustment command is used for achieving control over a thrust direction.

It should be noted that since the thrust direction is always fixedly connected to the fuselage, the direction of the rotational thrust coincides with the direction of the specific rotational force (as shown in FIG. 4) provided that the resistance is constant, the direction of the specific rotational force can be rotated by the direction of the rotational thrust (i.e., the direction of the fuselage).

In one embodiment, the S2021 step includes: a direction of the target specific force acceleration is calculated from the target acceleration in the acceleration adjustment command; a unit vector perpendicular to the direction of the target specific force acceleration and the direction of the current specific force acceleration of the multi-rotor unmanned aerial vehicle are taken as an axis vector; an included angle value is calculated from the direction of the target specific force acceleration and the direction of the current specific force acceleration; the current specific force acceleration is rotated about the axis vector by the included angle value to obtain a target angular speed; and the target angular acceleration adjustment command of the multi-rotor unmanned aerial vehicle is obtained according to the target angular speed.

For example, it can be seen from FIG. 3A that S_{R}=a_{R}−g

It is assumed that the direction of the target specific force acceleration is defined as follows:

$${n}_{S R} = \frac{{S}_{R}}{‖ {S}_{R} ‖}$$

where |S_{R}∥ the modulus of the target specific force acceleration, i.e., the magnitude of the target specific force acceleration, satisfies the following formula:

$$‖ {S}_{R} ‖ = \sqrt{{\sum }_{i = 1}^{n} {{S}_{R} ( i )}^{2}}$$

where n=3, and i denotes the x, y, z axis of the fuselage coordinate system or world coordinate system.

Similarly, the current direction of the specific force is:

$${n}_{s} = \frac{S}{‖ S ‖}$$

thus, the value ρ of the included angle value between the target specific force and the current specific force can be calculated (as shown in FIG. 5):

$$ρ = arccos ( {n}_{S R} \cdot {n}_{S} )$$

the unit vector perpendicular to n_{SR} and n_{S} are defined as an axis vector n_{c}, satisfying the following formula:

$${n}_{c} = {n}_{S R} \times {n}_{S} / sin ρ$$

It can be seen from the geometric relationship that n_{SR} can be obtained by rotating the vector n_{S} around an axis n_{c} by an included angle value ρ, i.e., the direction of the target specific force acceleration can be obtained by rotating the current specific force acceleration around an axis n_{c} by an included angle value ρ.

Further, the target angular speed ω_{R} of the multi-rotor unmanned aerial vehicle can be obtained as:

$${ω}_{R}^{B} = {k}_{a t t} \cdot ρ {n}_{c}^{B}$$

where. The superscript B denotes the projection of the vector in the body coordinate system, kₐₜₜ representing the gain.

As a possible embodiment, after the target angular speed is obtained, the target angular speed can also be performed control allocation by an incremental nonlinear dynamic quasi-control (INDI) controller to obtain the target angular acceleration adjustment command, so as to improve the multi-rotor unmanned aerial vehicle's adaptability to uncertainties and improve the anti-interference capability.

In one embodiment, the obtaining the target angular acceleration adjustment command of the multi-rotor unmanned aerial vehicle according to the target angular speed includes: performing control allocation processing on the target angular speed based on an INDI controller, and forming the target angular acceleration adjustment command of the multi-rotor unmanned aerial vehicle according to the processing result.

For example, after obtaining the target angular speed ω_{R}^{B}, the target angular speed can be performed control allocation by the INDI controller according to the following formula to obtain the target angular acceleration M_{cmd}:

$${M}_{c m d} = {k}_{r a t e} ( {ω}_{R}^{B} - {ω}^{B} ) - α + {M}_{act} + {\dot{ω}}_{R}^{B}$$

where ω^{B} is the current angular speed of the multi-rotor unmanned aerial vehicle, kᵣₐₜₑ is the control gain, α is the measured aircraft acceleration, M_{act} is the current angular acceleration, and M_{cmd} is the target angular acceleration generated after passing through the unmanned aerial vehicle dynamic model.

S2022 Obtain a target specific force acceleration magnitude adjustment command according to a target acceleration in the acceleration adjustment command.

It should be noted that since the manner of controlling the magnitude of the specific force is achieved by controlling the magnitude of the thrust force, and when the resistance value is constant, the thrust force increases, the specific force increases; therefore, the target specific force acceleration magnitude adjustment command comprises a target thrust acceleration for adjusting the current thrust magnitude of the multi-rotor unmanned aerial vehicle to the target thrust magnitude.

In one embodiment, the obtaining the target specific force acceleration magnitude adjustment command according to the target acceleration in the acceleration adjustment command includes: calculating a magnitude of the target specific force acceleration from the target acceleration in the acceleration adjustment command; calculating a target thrust acceleration magnitude of the multi-rotor unmanned aerial vehicle from the magnitude of the target specific force acceleration and the magnitude of the drag acceleration received by the multi-rotor unmanned aerial vehicle; and forming a target specific force acceleration magnitude adjustment command according to the target thrust acceleration magnitude.

For example, assume that the magnitude of the target specific force acceleration is ∥S_{R}∥, the ∥S_{R}∥ and the target acceleration a_{R} satisfy the following formula:

S_{R}=a_{R}−g

$$‖ {S}_{R} ‖ = \sqrt{{\sum }_{i = 1}^{n} {{S}_{R} ( i )}^{2}}$$

Further, assume that T_{R} represents the target thrust acceleration of each rotor of the multi-rotor unmanned aerial vehicle, D represents the drag acceleration experienced by the multi-rotor unmanned aerial vehicle, and T_{R}, D, and S_{R} satisfy the following equations:

$${T}_{R} = {S}_{R} - D$$

As a possible embodiment, the following INDI controller can be designed to further optimize the magnitude of the target thrust acceleration to obtain the target thrust acceleration T_{cmd}:

$${T}_{c m d} = {T}_{a c t} + ‖ {S}_{R} ‖ - ‖ S ‖$$

where Tact is an initial target thrust acceleration, and is obtained according to the above-mentioned T_{R}, and T_{cmd} is a value of the target thrust acceleration calculated after passing through the INDI controller.

S2023 Form the specific force acceleration adjustment command of the multi-rotor unmanned aerial vehicle according to the target angular acceleration adjustment command and the target specific force acceleration magnitude adjustment command.

As a possible embodiment, the target angular acceleration adjustment command can realize the control over the thrust direction, the target specific force acceleration magnitude adjustment command can realize the control over the thrust magnitude, and the specific force acceleration adjustment command is formed according to the above-mentioned target angular acceleration adjustment command and the target specific force acceleration magnitude adjustment command, so that the control over the thrust magnitude and direction can be realized simultaneously.

In one embodiment, the S2023 step includes: control allocation is performed on the target angular acceleration adjustment command and the target specific force acceleration magnitude adjustment command by using an unmanned aerial vehicle dynamic model, and the specific force acceleration adjustment command of the multi-rotor unmanned aerial vehicle is formed according to the allocation result.

For example, after obtaining the target angular acceleration adjustment command and the target specific force acceleration magnitude adjustment command, a motor command for controlling each rotor can be formed for the flight configuration of the multi-rotor unmanned aerial vehicle, and then control allocation is performed through an unmanned aerial vehicle dynamic model to obtain a respective angular acceleration adjustment command and specific force acceleration magnitude adjustment command for specifically controlling each rotor, wherein the respective angular acceleration adjustment command and specific force acceleration magnitude adjustment command for each rotor constitute the specific force acceleration adjustment command of the multi-rotor unmanned aerial vehicle.

S203 Adjust a current thrust of the multi-rotor unmanned aerial vehicle to a target thrust according to the specific force acceleration adjustment command, so as to realize the adjustment of a flight speed of the multi-rotor unmanned aerial vehicle.

For example, after obtaining the specific force acceleration adjustment command, the multi-rotor unmanned aerial vehicle can acquire a target angular acceleration and a target thrust magnitude in the specific force acceleration adjustment command, realize the adjustment of the thrust direction according to the target angular speed, and realize the adjustment of the thrust magnitude according to the target thrust magnitude. By adjusting the thrust and direction of the multi-rotor unmanned aerial vehicle, the flight speed of the unmanned aerial vehicle can be changed, and the flight speed of the multi-rotor unmanned aerial vehicle can be adjusted.

It can be seen that according to the method of the embodiments of the present application: the multi-rotor unmanned aerial vehicle acquires a speed adjustment command and obtains a specific force acceleration adjustment command according to the speed adjustment command; obtains a specific force acceleration adjustment command according to the acceleration adjustment command; and adjusts a current thrust of the multi-rotor unmanned aerial vehicle to a target thrust according to the specific force acceleration adjustment command, so as to realize the adjustment of a flight speed of the multi-rotor unmanned aerial vehicle. The above-mentioned method can directly obtain the acceleration adjustment command from the speed adjustment command, and then obtain the specific force acceleration adjustment command from the acceleration command, and does not generate the attitude command, so it is not limited by the attitude of the multi-rotor unmanned aerial vehicle, and can ensure the speed control over the multi-rotor unmanned aerial vehicle at any attitude such as continuous rolling, and has a wider application range.

It should be noted that in the above-mentioned embodiments, there is not necessarily a certain order between the above-mentioned steps, and a person skilled in the art would have been able to understand, according to the description of the embodiments in the present application, that in different embodiments, the above-mentioned steps can be performed in different orders, i.e., can be performed in parallel, can be performed in exchange, etc.

As another aspect of embodiments of the present disclosure, embodiments of the present disclosure provide a speed control device. The speed control device may be a software module comprising a number of commands, which are stored in a memory, and a processor can access the memory and call the commands to execute so as to complete the speed control method set forth in the above-mentioned various embodiments.

In some embodiments, the speed control device may also be implemented as a hardware device, for example, the speed control device may be implemented as one or more chips, each of which may work in concert with each other to implement the speed control methods described in the above embodiments. As another example, the speed control device may be built from various types of logic devices, such as a general-purpose processor, a digital signal processor (DSP), an application specific integrated circuit (ASIC), a field programmable gate array (FPGA), a single chip microcomputer, an Acorn RISC Machine (ARM) or other programmable logic device, discrete gate or transistor logic, discrete hardware components, or any combination thereof.

Now referring to FIG. 5, which is a schematic structural diagram of a speed control device according to an embodiment of the present disclosure. The speed control device is applied to a multi-rotor unmanned aerial vehicle, and the speed control device 50 shown in FIG. 5 includes:
an acquisition module 501 configured to acquire a speed adjustment command;
an obtaining module 502 configured to obtain a specific force acceleration adjustment command according to the acceleration adjustment command; and obtain a specific force acceleration adjustment command according to the acceleration adjustment command; and
an adjustment module 503 configured to adjust a current thrust of the multi-rotor unmanned aerial vehicle to a target thrust according to the specific force acceleration adjustment command, so as to realize the adjustment of a flight speed of the multi-rotor unmanned aerial vehicle.

As one possible design, the obtaining module 502 is specifically configured to, when obtaining an acceleration adjustment command according to the speed adjustment command, acquire a target speed in the speed adjustment command when the speed adjustment command is received; calculate a target acceleration from the target speed and the current speed of the multi-rotor unmanned aerial vehicle from a proportion controller; and form an acceleration adjustment command according to the target acceleration.

As one possible design, the obtaining module 502 is specifically configured to, when obtaining a specific force acceleration adjustment command for the multi-rotor unmanned aerial vehicle according to the acceleration adjustment command, obtain a target angular acceleration adjustment command according to a target acceleration in the acceleration adjustment command, wherein the target angular acceleration adjustment command is used for achieving control over a thrust direction; obtain a target specific force acceleration magnitude adjustment command according to a target acceleration in the acceleration adjustment command; and form the specific force acceleration adjustment command of the multi-rotor unmanned aerial vehicle according to the target angular acceleration adjustment command and the target specific force acceleration magnitude adjustment command.

As one possible design, the obtaining model 502 is configured to obtain the target angular acceleration adjustment command according to the target acceleration in the acceleration adjustment command includes: calculate a direction of the target specific force acceleration from the target acceleration in the acceleration adjustment command; take a unit vector perpendicular to the direction of the target specific force acceleration and the direction of the current specific force acceleration of the multi-rotor unmanned aerial vehicle as an axis vector; calculate an included angle value from the direction of the target specific force acceleration and the direction of the current specific force acceleration; rotate the current specific force acceleration about the axis vector by the included angle value to obtain a target angular speed; and obtain the target angular acceleration adjustment command of the multi-rotor unmanned aerial vehicle according to the target angular speed.

As one possible design, the obtaining module 502 is specifically configured to, when obtaining the target angular acceleration adjustment command of the multi-rotor unmanned aerial vehicle according to the target angular speed, perform control allocation processing on the target angular speed based on an INDI controller, and form the target angular acceleration adjustment command of the multi-rotor unmanned aerial vehicle according to the processing result.

As one possible design, the obtaining module 502 is specifically configured to, when obtaining a target specific force acceleration magnitude adjustment command according to a target acceleration in the acceleration adjustment command, calculate a magnitude of the target specific force acceleration from the target acceleration in the acceleration adjustment command; calculate a target thrust acceleration magnitude of the multi-rotor unmanned aerial vehicle from the magnitude of the target specific force acceleration and the magnitude of the drag acceleration received by the multi-rotor unmanned aerial vehicle; and form a target specific force acceleration magnitude adjustment command according to the target thrust acceleration magnitude.

As one possible design, the obtaining module 502 is specifically configured to, when forming the specific force acceleration adjustment command of the multi-rotor unmanned aerial vehicle according to the target angular acceleration adjustment command and the target specific force acceleration magnitude adjustment command, perform control allocation on the target angular acceleration adjustment command and the target specific force acceleration magnitude adjustment command by using an unmanned aerial vehicle dynamic model, and form the specific force acceleration adjustment command of the multi-rotor unmanned aerial vehicle according to the allocation result.

It can be seen that the above-mentioned device acquires a speed adjustment command and obtains a specific force acceleration adjustment command according to the speed adjustment command; obtains a specific force acceleration adjustment command according to the acceleration adjustment command; and adjusts a current thrust of the multi-rotor unmanned aerial vehicle to a target thrust according to the specific force acceleration adjustment command, so as to realize the adjustment of a flight speed of the multi-rotor unmanned aerial vehicle. The acceleration adjustment command can be directly obtained from the speed adjustment command, and then obtain the specific force acceleration adjustment command from the acceleration command, and does not generate the attitude command, so it is not limited by the attitude of the multi-rotor unmanned aerial vehicle, and can ensure the speed control over the multi-rotor unmanned aerial vehicle at any attitude such as continuous rolling, and has a wider application range.

It should be noted that the above-mentioned speed control device can execute the speed control method provided by an embodiment of the present application, and has functional modules and advantageous effects corresponding to the execution method. For technical details not described in detail in the embodiment of the speed control device, reference can be made to the speed control method provided in an embodiment of the present application.

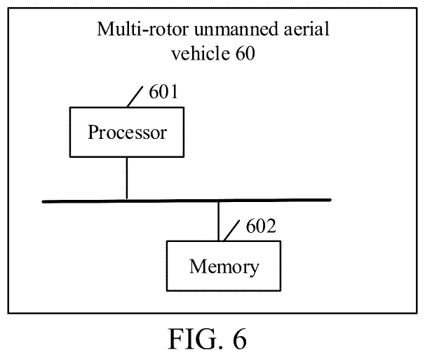

Now referring to FIG. 6, FIG. 6 is a schematic structural diagram showing a multi-rotor unmanned aerial vehicle according to an embodiment of the present invention. The multi-rotor unmanned aerial vehicle 60 includes a processor 601 and a memory 602. The memory 602 is connected to the processor 601, for example via a bus.

The processor 601 is configured to support the multi-rotor unmanned aerial vehicle to perform the corresponding functions in the methods of the above-described method embodiments. The processor may be a (CPU), a (NP), a hardware chip, or any combination thereof. The hardware chip may be an application specific integrated circuit (ASIC), a programmable logic device (PLD) or a combination thereof. The PLD may be a complex programmable logic device (CPLD), a field-programmable gate array, (FPGA), a generic array logic (GAL), or any combination thereof.

The memory 602 is used to store program codes, etc. The memory 602 may include volatile memory (VM), such as (RAM); the memory may also comprise a non-volatile memory (NVM), such as a read-only memory (ROM), a flash memory, a hard disk drive (HDD) or a solid-state drive (SSD); the memory 602 may also comprise a combination of memories of the kind described above.

The memory 602 may be used to store non-volatile software programs, non-volatile computer-executable programs, and modules, such n commands/modules corresponding to the speed control method in embodiments of the present application. The processor executes various functional applications of the speed control method and the speed control the speed control device by running non-volatile software programs, commands and modules stored in the memory, i.e., realizing the functions of the respective modules or units of the speed control method and the speed control device provided by the above-described method embodiments.

The memory may include a storage program area and a storage data area, wherein the storage program area may store an operating system, an application program required for at least one function. The storage data area may store data or the like created according to the use of the speed control device. In some embodiments, the memory may optionally include memory remotely located relative to the processor, which may be connected to the speed control device via a network. Embodiments of such networks include, but are not limited to, the Internet, Intranets, local area networks, mobile communication networks, and combinations thereof.

The one or more modules are stored in the memory and, when executed by the one or more processors, perform the speed control method in any of the above method embodiments, e.g., perform the method steps described in the above method embodiments, implement the functions of the modules described in the above device embodiments.

Embodiments of the present application also provide a computer-readable storage medium storing a computer program comprising program commands which, when executed by a computer, cause the computer to perform the method according to the preceding embodiments.

It will be appreciated by a person skilled in the art that implementing all or part of the flow of the methods of the embodiments described above can be accomplished by a computer program instructing the associated hardware, which program can be stored on a computer-readable storage medium, and which when executed can include the flow of the embodiments of the methods described above. The storage medium may be a magnetic disk, an optical disk, a Read-Only memory (ROM) or a Random-Access memory (RAM), etc.

While the present application has been described in connection with what is presently considered to be the most practical and preferred embodiment, it is to be understood that the present application is not to be limited to the disclosed embodiment, but on the contrary, is intended to cover various modifications and equivalent arrangements included within the spirit and scope of the appended claims.

1. A speed control method, wherein the speed control method is applied to a multi-rotor unmanned aerial vehicle, the method comprising:
acquiring a speed adjustment command and obtaining an acceleration adjustment command according to the speed adjustment command;
obtaining a specific force acceleration adjustment command according to the acceleration adjustment command; and
adjusting a current thrust of the multi-rotor unmanned aerial vehicle to a target thrust according to the specific force acceleration adjustment command, so as to realize the adjustment of a flight speed of the multi-rotor unmanned aerial vehicle.

2. The method according to claim 1, wherein the acquiring the speed adjustment command and obtaining the acceleration adjustment command according to the speed adjustment command comprises:
acquiring a target speed in the speed adjustment command when the speed adjustment command is received;
calculating a target acceleration from the target speed and the current speed of the multi-rotor unmanned aerial vehicle from a proportion controller; and
forming an acceleration adjustment command according to the target acceleration.

3. The method according to claim 2, wherein the obtaining the specific force acceleration adjustment command for the multi-rotor unmanned aerial vehicle according to the acceleration adjustment command comprises:
obtaining a target angular acceleration adjustment command according to a target acceleration in the acceleration adjustment command, wherein the target angular acceleration adjustment command is used for achieving control over a thrust direction;
obtaining a target specific force acceleration magnitude adjustment command according to a target acceleration in the acceleration adjustment command; and
forming the specific force acceleration adjustment command of the multi-rotor unmanned aerial vehicle according to the target angular acceleration adjustment command and the target specific force acceleration magnitude adjustment command.

4. The method according to claim 3, wherein the obtaining the target angular acceleration adjustment command according to the target acceleration in the acceleration adjustment command comprises:
calculating a direction of the target specific force acceleration from the target acceleration in the acceleration adjustment command;
taking a unit vector perpendicular to the direction of the target specific force acceleration and the direction of the current specific force acceleration of the multi-rotor unmanned aerial vehicle as an axis vector;
calculating an included angle value from the direction of the target specific force acceleration and the direction of the current specific force acceleration;
rotating the current specific force acceleration about the axis vector by the included angle value to obtain a target angular speed; and
obtaining a target angular acceleration adjustment command of the multi-rotor unmanned aerial vehicle according to the target angular speed.

5. The method according to claim 4, wherein the obtaining the target angular acceleration adjustment command of the multi-rotor unmanned aerial vehicle according to the target angular speed comprises:
performing control allocation processing on the target angular speed based on an INDI controller, and forming the target angular acceleration adjustment command of the multi-rotor unmanned aerial vehicle according to the processing result.

6. The method according to claim 3, wherein the obtaining the target specific force acceleration magnitude adjustment command according to the target acceleration in the acceleration adjustment command comprises:
calculating a magnitude of the target specific force acceleration from the target acceleration in the acceleration adjustment command;
calculating a target thrust acceleration magnitude of the multi-rotor unmanned aerial vehicle from the magnitude of the target specific force acceleration and the magnitude of the drag acceleration received by the multi-rotor unmanned aerial vehicle; and
forming a target specific force acceleration magnitude adjustment command according to the target thrust acceleration magnitude.

7. The method according to claim 3, wherein the forming the specific force acceleration adjustment command of the multi-rotor unmanned aerial vehicle according to the target angular acceleration adjustment command and the target specific force acceleration magnitude adjustment command comprises:
performing control allocation on the target angular acceleration adjustment command and the target specific force acceleration magnitude adjustment command by using an unmanned aerial vehicle dynamic model, and forming the specific force acceleration adjustment command of the multi-rotor unmanned aerial vehicle according to the allocation result.

8. A speed control device, wherein the speed control device is applied to a multi-rotor unmanned aerial vehicle, the device comprising:
an acquisition module configured to acquire a speed adjustment command;
an obtaining module configured to obtain a specific force acceleration adjustment command according to the acceleration adjustment command; and obtain a specific force acceleration adjustment command according to the acceleration adjustment command; and
an adjustment module configured to adjust a current thrust of the multi-rotor unmanned aerial vehicle to a target thrust according to the specific force acceleration adjustment command, so as to realize the adjustment of a flight speed of the multi-rotor unmanned aerial vehicle.

9. A multi-rotor unmanned aerial vehicle, comprising a memory, a processor coupled to the processor for executing one or more computer programs stored in the memory, the processor, when executing the one or more computer programs, causing the multi-rotor unmanned aerial vehicle to implement the method according to claim 1.

10. A computer-readable storage medium, wherein the computer-readable storage medium has stored thereon a computer program comprising program commands which, when executed by a processor, cause the processor to perform the method according to claim 1.
